(19) United States
(12) Patent Application Publication
(10) Pub. No.: US 2017/0255547 A1
(43) Pub. Date: Sep. 7, 2017

(54) SOURCE CODE ERROR DETECTION DEVICE AND METHOD THEREOF

(71) Applicant: MStar Semiconductor, Inc., Hsinchu Hsien (TW)

(72) Inventor: Huei-Jyun SONG, Hsinchu Hsien (TW)

(21) Appl. No.: 15/244,263

(22) Filed: Aug. 23, 2016

(30) Foreign Application Priority Data
Mar. 2, 2016 (TW) 105106395

(51) Int. Cl. G06F 11/36; G06F 9/44

(52) U.S. Cl. CPC G06F 11/3668; G06F 8/71

(57) ABSTRACT

A source code error detection device and a source code error detection method are disclosed. The device and method are applied to detect source codes of a software product. The software product includes a plurality of function modules. A database stores the source codes of multiple versions of these function modules. Each version of the each module corresponds to a version information. The source code error detection device and the source code error detection method find an erroneous version information in order to immediately identify the source of the erroneous source codes during the development of a software project.

This application claims the benefit of Taiwan application Serial No. 105106395, filed Mar. 2, 2016, the subject matter of which is incorporated herein by reference.

### BACKGROUND OF THE INVENTION

Field of the Invention

The invention relates in general to a source code error detection device and error detection method, and more particularly to a source code error detection device and error detection method capable of tracking back to the earliest erroneous version information of source codes.

Description of the Related Art

The final output of a software project is an operable product. During the development of software, the product is divided into different function modules based on functions. These function modules are individually developed by different units and then integrated into the product. However, an integration failure may occur when the product is to be released. If the integration is conducted just before the product is released, substantial numbers of versions of the modules may have been accumulated. Identifying the source of error from multiple version combinations of multiple modules is undoubtedly an extremely time-consuming task. Therefore, there is a need for an associated device and method for enhancing the efficiency of releasing a product to reduce the development time of a software project.

### SUMMARY OF THE INVENTION

It is an object of the present invention to provide a source code error detection device and error detection method to enhance the efficiency of releasing a product and reduce the development time of a software project.

The present invention discloses a source code error detection device. A database stores source codes of a plurality of versions of a plurality of function modules. Each version of each function module corresponds to version information. The source code error detection device, adapted to find erroneous version information, includes: a storage unit, storing a plurality of program instructions; and a processing unit, coupled to the storage unit, executing the program instructions to perform steps of: a) obtaining a compile combination information list, which includes a plurality of sets of compile combination information corresponding to a plurality of compile combinations, wherein the sets of compile combination information are arranged according to a module adding time sequence, and each set of compile combination information includes compile combination version information; b) selecting a target compile combination from the compile combination combinations; c) retrieving the source codes corresponding to the function modules of the target compile combination from the database according to the compile combination version information of the target compile combination; d) compiling the source codes to generate a compiled result of the target compile combination; e) determining whether an adjacent compile combination, which is one of a previous compile combination and a next compile combination of the target compile combination, has been compiled according the compiled result of the target compile combination; f) when the adjacent compile combination has been compiled, determining whether the compiled result of the target compile combination is opposite to a compiled result of the adjacent compile combination; and g) when the compiled result of the target compile combination is opposite to the compiled result of the adjacent compile combination, identifying the erroneous version information according to the compile combination information of the target compile combination and the compile combination information of the adjacent compile combination.

The present invention further discloses a source code error detection method. A database stores source codes of a plurality of versions of a plurality of function modules. Each version of each function module corresponds to version information. The source code error detection method is for finding erroneous version information, and includes steps of: a) obtaining a compile combination information list, which includes a plurality of sets of compile combination information corresponding to a plurality of compile combinations, wherein the sets of compile combination information are arranged according to a module adding time sequence, and each set of compile combination information includes compile combination version information; b) selecting a target compile combination from the plurality of compile combinations; c) retrieving the source codes corresponding to the function modules of the target compile combination from the database according to the compile combination version information of the target compile combination; d) compiling the source codes to generate a compiled result of the target compile combination; e) determining whether an adjacent compile combination, which is one of a previous compile combination and a next compile combination of the target compile combination, has been compiled according the compiled result of the target compile combination; f) when the adjacent compile combination has been compiled, determining whether the compiled result of the target compile combination is opposite to a compiled result of the adjacent compile combination; and g) when the compiled result of the target compile combination is opposite to the compiled result of the adjacent compile combination, identifying the erroneous version information according to the compile combination information of the target compile combination and the compile combination information of the adjacent compile combination.

The source code error detection device and error detection method of the present invention continues compiling the numerous version combinations of the source codes, so as to detect and identify the source of the erroneous source code at an initial stage of the error in a way that the error is not propagated. Compared to known technologies, the present invention is capable of immediately identifying the source of the erroneous source code, thereby preventing spending excessive time and manpower costs in identifying the erroneous source code in the event of a product integration failure.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a source code error detection device according to an embodiment of the present invention; and

FIG. 2 is a flowchart of a source code error detection method according to an embodiment of the present invention.

### DETAILED DESCRIPTION OF THE INVENTION

The disclosure of the present invention includes a source code error detection device and error detection method capable of detecting the source of an erroneous source code. In possible implementation, one skilled person in the art may choose equivalent elements or steps to implement the present invention based on the disclosure of the present invention. That is, the implementation of the present invention is not limited by the embodiments disclosed in the application.

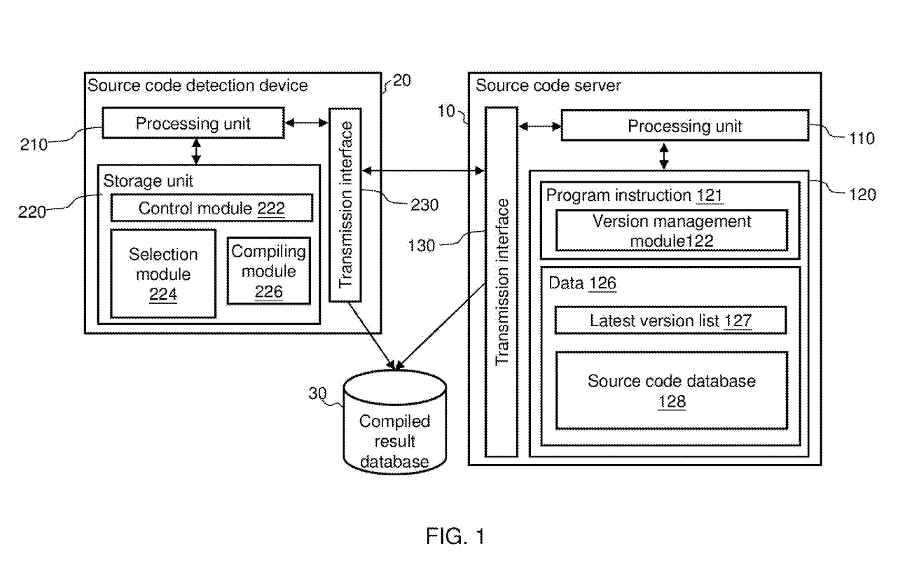

FIG. 1 shows a block diagram of a source code error detection device according to an embodiment of the present invention. A source code error detection device 20 is coupled to a source code server 10 and a compiled result database 30. The source code server 10 includes a processing unit 110, a storage unit 120 and a transmission interface 130. The storage unit 120 is implemented by a non-volatile memory, e.g., a hard drive, solid-state drive (SSD) or a flash, for storing program instructions 121 and data 126. The program instructions 121 include a version management module 122. The processing unit 110 executes the program instructions corresponding to the version management module 122 to implement its function. The data 126 includes a latest version list 127 and a source code database 128. In different embodiments, the latest version list 127 and the source code database 128 may be stored in different storage units.

The version management module 122 provides a user interface, through which a user adds source codes of a module to the source code server 10 and provides associated information of the module, e.g., information such as module name, version number, program developer. After the source code server 10 receives the source codes of the module and the associated information through the transmission interface 130 (e.g., an Ethernet transmission interface), the version management module 122 stores the source codes of the module to the source code database 128, and updates the latest version list 127 according to the associated information of the module. The latest version list 127 records the latest version numbers of the modules for at least one software product in the source code server 10. For example, assuming that one software product includes five modules AB1 to AB5, the latest version list 127 corresponding to that software product may be shown as Table-1 below:

TABLE 1

| Module Name | AB1 | AB2 | AB3 | AB4 | AB5 |
|---|---|---|---|---|---|
| Latest version number | CL123 | CL456 | CL789 | CL357 | CL135 |

In addition to updating the latest version list 127 and the source code database 128, each time the user adds source codes of a module, the version management module 122 updates a compile combination information list stored in the compiled result database 30. For example, at the 0^{th} minute, the user adds source codes of the module AB4 to the source code server 10, and its version number is CL357. After updating the latest version list 127, the version management module 122 adds compile combination information corresponding to a compile combination to the compile combination information list, as shown in Table-2, according to the module adding time and the latest version numbers of all of the modules in the latest version list 127 (as shown in Table-1, where the latest version number of the module AB1 is CL123, the latest version number of the module AB2 is CL456, and so forth). For example, the compile combination information includes module adding time information, newly-added module version information and compile combination version information. It should be noted that, in Table-2, the 0^{th} minute at which the module adding time serves to represent a relative time point, and there may be at least one compile combination before the 0^{th} minute.

TABLE 2

| Module | Newly-added | | |
|---|---|---|---|
| adding | module | Compile combination | Compiled |
| time | version | version | result |
| . . . | . . . | . . . | . . . |
| 0^{th} | AB4(CL357) | AB1(CL123)AB2(CL456) | Non-compiled |
| minute | | AB3(CL789)AB4(CL357) | |
| | | AB5(CL135) | |

The error detection device 20 includes a processing unit 210, a storage unit 220 and a transmission interface 230. The storage unit 220 is implemented by a non-volatile memory, e.g., a magnetic drive, a solid-state drive (SSD) or a flash, for storing a plurality of program instructions. The processor 210 executes these program instructions to achieve the function of the detection device 20. Based on different functions, the program instructions may be divided into different function modules, e.g., at least a control module 222, a selection module 224 and a compiling module 226. The control module 222 controls an error detection procedure of the error detection device 20. The selection module 224 selects a target compile combination. The compiling module 226 compiles the target compile combination. For example, the transmission interface 230 is an Ethernet transmission interface.

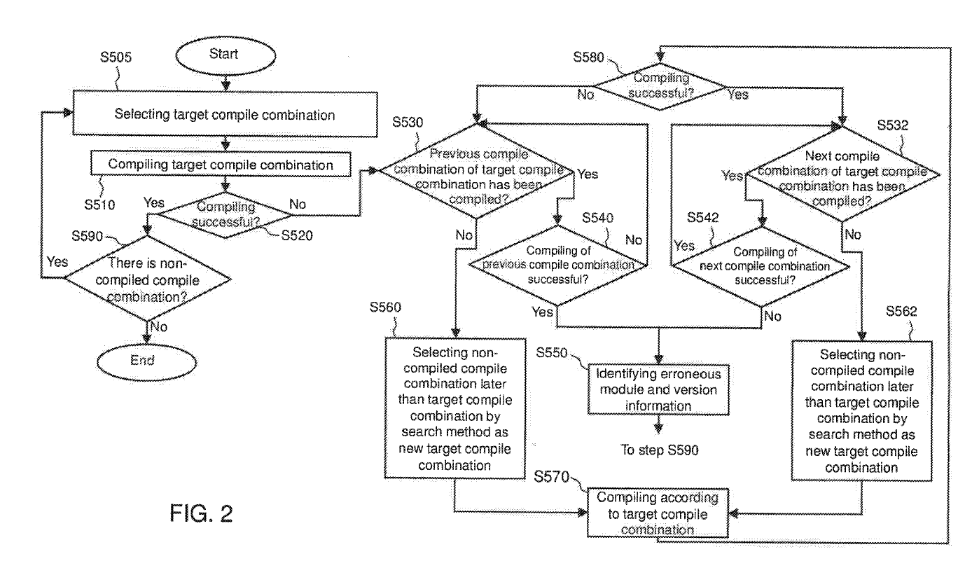

The source code error detection method according to an embodiment is described as below with reference to the flowchart in FIG. 2. First of all, the selection module 224 selects a latest compile combination from non-compiled compile combinations in the compile combination information list as a target compile combination (step S505). Taking Table-2 for instance, as there is only one non-compiled compile combination (i.e., the compile combination of the 0^{th} minute), the selection module 224 selects the compile combination of the 0^{th} minute as the target compile combination.

The compiling module 226 then performs a compiling process according to the compile combination version information of the target compile combination (step S510). Taking Table-2 for instance, according to the compile combination version information of the target compile combination AB1(CL123)AB2(CL456)AB3(CL789)AB4(CL357)AB5(CL135), the compiling module 226 selects, from the source code server 10 through the transmission interface 230, the source codes in the version number CL123 for the module AB1, the source codes in the version number CL456 for the module AB2, the source codes in the version number CL789 for the module AB3, the source codes in the version number CL357 for the module AB4 and the source codes in the version number CL135 for the module AB5 to compile, to generate a compiled result of the target compile combination. Further, the compiling module 226 updates the compile combination information list according to the compiled result. For example, assuming that the compiling module 226 is capable of generating a software product such as binary codes after compiling, the compiled result is marked as successful, otherwise is marked as failed.

Next, the control module 222 determines whether the compiled result of the target compile combination is successful (step S520). If this compiled result is successful, the control module 222 then determines whether there is any non-compiled compile combination in the compile combination information list (step S590). If there is no non-compiled compile combination in the compile combination information list, the process of the error detection method ends.

If there is still non-compiled compile combination in the compile combination information list, the selection module 224 again selects a latest compile combination from the non-compiled compile combinations in the compile combination information list as the target compile combination (step S505).

For example, during the process of compiling the target compile combination, new source codes of at least one module may be newly added to the source code server 10, and the version management module 122 accordingly updates the latest version list 127. In the above example, assuming that the compiling module 226 spends 10 minutes for each compiling process, the compile combination starting at 0^{th} minute is completely compiled at the 10^{th} minute. However, the new source codes of the modules AB5, AB1, AB2 and AB2 may be added to the source code server 10 at the 3^{rd}, 5^{th}, 7^{th} and 8^{th} minutes, respectively, with the newly-added version numbers respectively being CL967, CL647, CL635 and CL847. Thus, when the compile combination of the 0^{th} minute is completely complied (i.e., at the 10^{th} minute), the compile combination information list is updated by the version management module 122 as shown in Table-3.

TABLE 3

| Module | Newly-added | | |
|---|---|---|---|
| adding | module | Compile combination | Compiled |
| time | version | version | result |
| . . . | . . . | . . . | Successful |
| 0^{th} | AB4(CL357) | AB1(CL123)AB2(CL456) | Successful |
| minute | | AB3(CL789)AB4(CL357) | |
| | | AB5(CL135) | |
| 3^{rd} | AB5(CL967) | AB1(CL123)AB2(CL456) | Non-compiled |
| minute | | AB3(CL789)AB4(CL357) | |
| | | AB5(CL967) | |
| 5^{th} | AB1(CL647) | AB1(CL647)AB2(CL456) | Non-compiled |
| minute | | AB3(CL789)AB4(CL357) | |
| | | AB5(CL967) | |
| 7^{th} | AB2(CL635) | AB1(CL647)AB2(CL635) | Non-compiled |
| minute | | AB3(CL789)AB4(CL357) | |
| | | AB5(CL967) | |
| 8^{th} | AB2(CL847) | AB1(CL647)AB2(CL847) | Non-compiled |
| minute | | AB3(CL789)AB4(CL357) | |
| | | AB5(CL967) | |

As there are still non-compiled compile combinations in the compile combination information list as shown in Table-3, the selection module 224 selects the latest non-compiled compile combination (i.e., the compile combination at the 8^{th} minute) in the compile combination information list as shown in Table-3 as a new target compile combination (step S505). Next, the compiling module 226 performs a compiling process according to the compile combination version information of the compile combination at the 8^{th} minute (step S510).

Assuming that the compiled result of the compile combination at the 8^{th} minute is failed, the compile combination information list is updated as shown in Table-4.

| Module | Newly-added | | |
|---|---|---|---|
| adding | module | Compile combination | Compiled |
| time | version | version | result |
| . . . | . . . | . . . | . . . |
| 0^{th} | AB4(CL357) | AB1(CL123)AB2(CL456) | Successful |
| minute | | AB3(CL789)AB4(CL357) | |
| | | AB5(CL135) | |
| 3^{rd} | AB5(CL967) | AB1(CL123)AB2(CL456) | Non-compiled |
| minute | | AB3(CL789)AB4(CL357) | |
| | | AB5(CL967) | |
| 5^{th} | AB1(CL647) | AB1(CL647)AB2(CL456) | Non-compiled |
| minute | | AB3(CL789)AB4(CL357) | |
| | | AB5(CL967) | |
| 7^{th} | AB2(CL635) | AB1(CL647)AB2(CL635) | Non-compiled |
| minute | | AB3(CL789)AB4(CL357) | |
| | | AB5(CL967) | |
| 8^{th} | AB2(CL847) | AB1(CL647)AB2(CL847) | Failed |
| minute | | AB3(CL789)AB4(CL357) | |
| | | AB5(CL967) | |

As the compiled result of the compile combination at the 8^{th} minute is failed, the control module 222 then determines whether the previous compile combination of the compile combination at the 8^{th} minute (i.e., the compile combination at the 7^{th} minute) has been compiled (step S530). It should be noted that, the so-called previous or next compile combination is with respect to the module adding time.

Since the compile combination at the 7^{th} minute has not been compiled, the selection module 224 selects a non-compiled compile combination earlier than the target compile combination by a search method as a new target compile combination (step S560). In this embodiment, the selection module 224 uses a binary search method to select the new target compile combination. For example, among the compile combinations at the 3^{rd}, 5^{th} and 7^{th} minutes, the selection module 224 selects the compile combination with the middle module adding time (i.e., the compile combination at the 5^{th} minute) as the new target compile combination. In different embodiments, the selection module 224 may select the new target compile combination by other search methods, e.g., a sequential search method.

Further, the compiling module 226 performs a compiling process according to the compile combination version information of the compile combination at the 5^{th} minute (step S570). The control module 222 then determines whether its compiled result is successful (step S580). If the compiled result is successful, the control module 222 determines whether a next compile combination of the target compile combination has been compiled (step S532). Conversely, if the compiled result is failed, the control module 222 determines whether a previous compile combination of the target compile combination has been compiled (step S530).

For example, assuming that the compiled result of the compile combination at the 5^{th} minute is successful, the compile combination information list is updated as shown in Table-5.

TABLE 5

| Module | Newly-added | | |
|---|---|---|---|
| adding | module | Compile combination | Compiled |
| time | version | version | result |
| . . . | . . . | . . . | . . . |
| 0^{th} | AB4(CL357) | AB1(CL123)AB2(CL456) | Successful |
| minute | | AB3(CL789)AB4(CL357) | |
| | | AB5(CL135) | |
| 3^{rd} | AB5(CL967) | AB1(CL123)AB2(CL456) | Non-compiled |
| minute | | AB3(CL789)AB4(CL357) | |
| | | AB5(CL967) | |
| 5^{th} | AB1(CL647) | AB1(CL647)AB2(CL456) | Successful |
| minute | | AB3(CL789)AB4(CL357) | |
| | | AB5(CL967) | |
| 7^{th} | AB2(CL635) | AB1(CL647)AB2(CL635) | Non-compiled |
| minute | | AB3(CL789)AB4(CL357) | |
| | | AB5(CL967) | |
| 8^{th} | AB2(CL847) | AB1(CL647)AB2(CL847) | Failed |
| minute | | AB3(CL789)AB4(CL357) | |
| | | AB5(CL967) | |
| 15^{th} | AB3(CL906) | AB1(CL647)AB2(CL847) | Non-compiled |
| minute | | AB3(CL906)AB4(CL357) | |
| | | AB5(CL967) | |
| 17^{th} | AB4(CL815) | AB1(CL647)AB2(CL847) | Non-compiled |
| minute | | AB3(CL906)AB4(CL815) | |
| | | AB5(CL967) | |

Since the compiled result of the compile combination at the 5^{th} minute is successful, the control module 222 determines whether the compile combination t the 7^{th} minute has been compiled (step S532). Since the compile combination at the 7^{th} minute has not been compiled, the selection module 224 selects a non-compiled compile combination later than the target compile combination by a search method as a new target compile combination (step S562). In this embodiment, the selection module 224 uses a binary search method to select the new target compile combination. In this example, the selection module 224 selects the compile combination at the 7^{th} minute as the new target compile combination.

Next, the compiling module 226 performs a compiling process according to the compile combination version information of the compile combination at the 7^{th} minute (step S570).

Two different situations where the compiled result of the compile combination of the 7^{th} minute is successful and failed are described below.

In the first situation, the compiled result of the compiled combination at the 7^{th} minute is successful. The control module 222 then determines that the next compile combination (i.e., the compile combination at the 8^{th} minute) has been compiled (step S532) and that the compiled result of the compile combination at the 8^{th} minute is failed (step S542), and so the control module 222 identifies the version information causing the compiling failure (i.e., the erroneous version information) according to the compile combination information list (step S550). In step S550, as the compiled result of the target compile combination (i.e., the compile combination of the 7^{th} minute) is successful, the control module 222 regards the newly-added module version information of the next compile combination of the target compile combination (i.e., AB2(CL847)) as the erroneous version information.

In the second situation, the compiled result of the compile combination at the 7^{th} minute is failed. The control module 222 then determines that the previous compile combination (i.e., the compile combination at the 5^{th} minute) has been compiled (step S530) and that the compiled result of the compile combination at the 5^{th} minute is successful (step (S540), and so the control module 222 identifies the erroneous version information according to the compile combination information list (step S550). In step 550, as the compiled result of the target compile combination (i.e., the compile combination at the 7^{th} minute) is failed, the control module 222 regards the newly-added module version information of the target compile combination (i.e., AB2(CL635)) as the erroneous version information.

In fact, the concept of the error detection process is identifying the erroneous version information by identifying two adjacent compile combinations having different compiled results. In the embodiment, because the compile combination information list records the newly-added module version of each compile combination, the control module 222 is capable of quickly obtaining the erroneous version information from the field of the newly-added module version in the compile combination information list. However, in other embodiments, if the compile combination information list does not include the field of the newly-added module version, the control module 222 is nonetheless capable of identifying the erroneous version information by comparing the compile combination version information of two adjacent compile combinations having different compiled results. In other words, regardless of whether the compile combination information list includes the field of the newly-added module version, the erroneous version information can be quickly identified according to the embodiments of the present invention.

It should be noted that, in the above embodiments, the error detection device 20 is located outside the source code server 10. However, in other embodiments, the error detection device 20 may be integrated in the source code server 10. Further, in other embodiments, the compile result database 30 may be integrated in the source code server 10 together with the error detection device 20.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A source code error detection device, a database storing source codes of a plurality of versions of a plurality of function modules, each version of each function module corresponding to version information, the source code error detection device adapted to identify erroneous version information, the source code error detection device comprising:
a storage unit, storing a plurality of program instructions; and
a processing unit, coupled to the storage unit, executing the program instructions to perform steps of:
a) obtaining a compile combination information list, wherein the compile combination information list comprises a plurality of sets of compile combination information corresponding to a plurality of compile combinations, the sets of compile combination information arranged according to a module adding time sequence, each set of compile combination information comprising compile combination version information;
b) selecting a target compile combination from the compile combinations;
c) retrieving the source codes of the function modules corresponding to the target compile combination from the database according to the compile combination version information of the target compile combination;
d) compiling the source codes to generate a compiled result of the target compile combination;
e) determining whether an adjacent compile combination, which is one of a previous compile combination and a next compile combination of the target compile combination, has been compiled according to the compiled result of the target compile combination;
f) when the adjacent compile combination has been compiled, determining whether the compiled result of the target compile combination is opposite to a compiled result of the adjacent compile combination; and
g) when the compiled result of the target compile combination is opposite to the compiled result of the adjacent compile combination, identifying the erroneous version information according to the compile combination information of the target compile combination and the compile combination information of the adjacent compile combination.

2. The source code error detection device according to claim 1, wherein
step (e) comprises:
determining whether the compiled result of the target compile combination is successful or failed; and
when the compiled result of the target compile combination is failed, determining whether the previous compile combination of the target compile combination has been compiled.

3. The source code error detection device according to claim 2, wherein the compile combination information further comprises newly-added module version information, and step (f) comprises:
when the previous compile combination of the target compile combination has been compiled, determining whether a compiled result of the previous compile combination is successful; and
step (g) comprises:
when the compiled result of the previous compile combination is successful, utilizing the newly-added module version information in the target compile combination as the erroneous version information.

4. The source code error detection device according to claim 1, wherein step (e) comprises:
determining whether the compiled result of the target compile combination is successful or failed; and
when the compiled result of the target compile combination is successful, determining whether the next compile combination of the target compile combination has been compiled.

5. The source code error detection device according to claim 4, wherein the compile combination information further comprises newly-added module version information, and step (f) comprises:
when the next compile combination of the target compile combination has been compiled, determining whether a compiled result of the next compile combination is failed; and
step (g) comprises:
when the compiled result of the next compile combination is failed, utilizing the newly-added module version information in the next compile combination as the erroneous version information.

6. The source code error detection device according to claim 1, wherein the processing unit further executes the program instructions to perform steps of:
h) when the adjacent compile combination has not been compiled, selecting another target compile combination from the compile combinations by a search method.

7. The source code error detection device according to claim 6, wherein the search method is a binary search method.

8. The source code error detection device according to claim 6, wherein step (h) comprises:
according to the compiled result of the target compile combination, selecting one compile combination with earlier module adding time or later module adding time from the compile combinations as the another target compile combination.

9. The source code error detection device according to claim 8, wherein step (h) comprises:
determining whether the compiled result of the target compile combination is successful or failed; and
when the compiled result of the target compile combination is failed, selecting a compile combination with earlier module adding time from the compile combinations as the another target compile combination.

10. The source code error detection device according to claim 8, wherein step (h) comprises:
determining whether the compiled result of the target compile combination is successful or failed; and
when the compiled result of the target compile combination is successful, selecting a compile combination with later module adding time from the compile combinations as the another target compile combination.

11. A source code error detection method, a database storing source codes of a plurality of versions of a plurality of function modules, each version of each function module corresponding to version information, the source code error detection method for identifying erroneous version information, the source code error detection method comprising:
a) obtaining a compile combination information list, the compile combination information list comprising a plurality of sets of compile combination information corresponding to a plurality of compile combinations, the sets of compile combination information arranged according to a module adding time sequence, each set of compile combination information comprising compile combination version information;
b) selecting a target compile combination from the compile combinations;
c) retrieving the source codes of the function modules corresponding to the target compile combination from the database according to the compile combination version information of the target compile combination;
d) compiling the source codes to generate a compiled result of the target compile combination;
e) determining whether an adjacent compile combination, which is one of a previous compile combination and a next compile combination of the target compile combination, has been compiled according to the compiled result of the target compile combination;
f) when the adjacent compile combination has been compiled, determining whether the compiled result of the target compile combination is opposite to a compiled result of the adjacent compile combination; and
g) when the compiled result of the target compile combination is opposite to the compiled result of the adjacent compile combination, identifying the erroneous version information according to the compile combination information of the target compile combination and the compile combination information of the adjacent compile combination.

12. The source code error detection method according to claim 11, wherein step (e) comprises:
determining whether the compiled result of the target compile combination is successful or failed; and
when the compiled result of the target compile combination is failed, determining whether the previous compile combination of the target compile combination has been compiled.

13. The source code error detection method according to claim 12, wherein the compile combination information further comprises newly-added module version information, and step (f) comprises:
when the previous compile combination of the target compile combination has been compiled, determining whether a compiled result of the previous compile combination is successful; and
step (g) comprises:
when the compiled result of the previous compile combination is successful, utilizing the newly-added module version information in the target compile combination as the erroneous version information.

14. The source code error detection method according to claim 11, wherein step (e) comprises:
determining whether the compiled result of the target compile combination is successful or failed; and
when the compiled result of the target compile combination is successful, determining whether the next compile combination of the target compile combination has been compiled.

15. The source code error detection method according to claim 14, wherein the compile combination information further comprises newly-added module version information, and step (f) comprises:
when the next compile combination of the target compile combination has been compiled, determining whether a compiled result of the next compile combination is failed; and
step (g) comprises:
when the compiled result of the next compile combination is failed, utilizing the newly-added module version information in the next compile combination as the erroneous version information.

16. The source code error detection method according to claim 11, further comprising:
h) when the adjacent compile combination has not been compiled, selecting another target compile combination from the compile combinations by a search method.

17. The source code error detection method according to claim 16, wherein the search method is a binary search method.

18. The source code error detection method according to claim 16, wherein step (h) comprises:
according to the compiled result of the target compile combination, selecting one compile combination with earlier module adding time or later module adding time from the compile combinations as the another target compile combination.

19. The source code error detection method according to claim 18, wherein step (h) comprises:
determining whether the compiled result of the target compile combination is successful or failed; and
when the compiled result of the target compile combination is failed, selecting a compile combination with earlier module adding time from the compile combinations as the another target compile combination.

20. The source code error detection method according to claim 18, wherein step (h) comprises:
determining whether the compiled result of the target compile combination is successful or failed; and
when the compiled result of the target compile combination is successful, selecting a compile combination with later module adding time from the compile combinations as the another target compile combination.
